(19) United States
(12) Patent Application Publication
(10) Pub. No.: US 2005/0097210 A1
(43) Pub. Date: May 5, 2005

(54) Computer address resolution

(75) Inventors: Paul Martyn Kane, London (GB); Moses John McKinlay, Poole (GB)

Correspondence Address: D. Douglas Price;Steptoe & Johnson LLP, 1330 Connecticut Avenue, N.W., Washington, DC, 20036, US

(73) Assignee: Internet Computer Bureau Plc

(21) Appl. No.: 10/725,532

(22) Filed: Dec. 3, 2003

(30) Foreign Application Priority Data
Nov. 5, 2003 (GB) 0325835.7

(51) Int. Cl. G06F 15/173

(52) U.S. Cl. 709/225; 709/227

(57) ABSTRACT

A method and apparatus are provided for resolving an unknown address request in a computer system. The name is received at the first server with a request for an address corresponding to that name. The name is compared with a database of names to detect any matching name in the database. If no matching name is detected a referral response is sent in answer to the request.

### FIELD OF THE INVENTION

This invention relates to method and apparatus for computer address resolution and particularly to a method and apparatus for directing users of programs such as World Wide Web browsers to configured sites.

### BACKGROUND TO THE INVENTION

In recent years use of the World Wide Web and Internet has increased considerably. Access is frequently made by an individual with a personal computer running a World Wide Web browser, an e-mail client, or by using a mobile access device such as a cellular telephone. In each case, virtual connections are made using the Internet Protocol (IP) which encodes messages in a way which can be transmitted using a variety of medium, such as telephone lines or cellular packet-based data telecommunications. IP communications take place using IP addresses, which are used to identify the source, destination and intermediate hosts used by an IP communications channel. These IP addresses are not considered “user-friendly”, and as such a mechanism exists by which human-readable names can be translated into numerical IP addresses in order to create IP connections; this translation system is known as the Domain Name System (DNS).

DNS is a communications protocol based around the concept of requests and responses; that is, DNS works on the basis of a series of short conversations—a question, and an answer. The question typically consists of two parts—a name, and a query type. The name part of the question is the domain name for which the client requires information. The query type is slightly more complicated, however. DNS allows many different kinds of information to be stored regarding a particular domain name, and the query type allows the client to choose which type of information they require. In return, the answer contains a domain name, and a record type, and each answer may contain several records—or entries—which are returned to the client together. Answers can be split into three categories: direct answers, referrals and negative responses.

Direct answers are returned to a client where a DNS server computer has all of the information available to it in order to immediately answer the question asked by the client. In contrast, referrals are returned to a client where a DNS server must return the name of another DNS server which is able to properly answer the question asked by the client. Negative responses are returned to a client in the situation where there is no information available regarding a domain name whatsoever. This typically occurs when a domain name does not exist—in this scenario, there are no servers to refer the client to, and there is no information to return to the client. DNS itself is a hierarchical system; DNS domain names are arranged in trees, and it is possible to obtain information about a given domain name by starting at the root (top level) servers and repeatedly following the referral answers given in response to requests until the server responsible for the requested domain name is reached. For example, in order to find information about the domain name www.example.com, a client will first contact a root DNS server, which will respond with a referral to the DNS servers responsible for the com domain. The client will select one of the DNS servers contained within the referral (using an implementation-specific algorithm) and perform the query again. The DNS server responsible for the com domain will then return a referral response directing the client at the servers responsible for the example.com domain. In turn, when queried, these servers will return the requested information regarding www.example.com.

It is important to note that the DNS servers responsible for the con domain, for example, have no knowledge of www.example.com—the servers responsible for the com domain only hold information regarding domain names contained directly within their sphere of control.

Additionally, a request for information for example.com may result in a negative response, whereas a request for information for www.example.com may result in a direct answer. This is a different kind of negative response which indicates that “no address is available” rather than “the domain name does not exist”. DNS client software may often treat these two kinds of negative responses differently. In the former case, the response indicates that although no address is available for the requested name, subsidiary domains may exist. The latter indicates that the domain name does not exist at all, and the DNS client software is free to automatically return a negative response for any requests for information, for subsidiary domains without performing a full lookup sequence.

There is a mechanism in existence whereby a DNS server returns a direct answer where it would normally return a negative response. This mechanism is termed a “wildcard” record, and it specifies the information that a DNS server should return if no other information is available. It is not possible, however, to return a referral response by the same means as a direct answer wildcard. In many situations, the use of a wildcard record can have many detrimental effects. Specifically, a wildcard works only at a single depth level—that is, a wildcard Address record within the com domain will result in direct answers being generated in response to every query within that domain.

As an example, consider e-mail; if a wildcard is present which causes a specific address to be returned to DNS clients for every query sent to the com DNS servers which is for a domain name which does not exist, then at an application level, all domain names within the corn domain now exist. For World Wide Web users, this does not pose a problem—and might indeed be the intended behaviour—as the address returned might be that of a World Wide Web server which displays a page listing existing domain names which are similar to the name entered by the user (for example to help users correct typographical errors). Unfortunately, this mechanism also affects other applications—in this example, if a user were to send an e-mail message to someuser@nonexistant.com, the wildcard would take effect and cause e-mail, as well as World Wide Web traffic, to be directed at the wildcard address. Therefore, a different mechanism is required in situations where directing users of only a specific protocol—rather than all protocols—to a default address. Fortunately, some applications contain mechanisms which aid this. Many popular World Wide Web browser programs will automatically attempt to contain www.example.com if no address information could be found for example.com. Because ‘www’ is specific to the World Wide Web, other applications will not under normal circumstances attempt to prepend this sub-domain. If it were possible to create some kind of ‘second-level’ wildcard—whereby queries for www.nonexistant.com returned a direct answer, but queries for nonexistant.com itself did not, then this would avoid the use of wildcards, along with the problems associated with them.

### SUMMARY OF THE INVENTION

In accordance with an embodiment of the invention there is provided a method for resolving Internet address requests sent to a Domain Name System server computer whereby the requested domain name is compared with names contained within a database, and if that name is not present a referral response is automatically generated and returned to the client; this referral response contains the names or addresses of a second Domain Name System server which most clients shall subsequently contact to continue the address resolution process. When the second Domain Name System server receives a resolution request, it compares the first component of the domain name with a configured value (for example, www), and the requested record type with a second configured value (for example, Address type records). If there is a match in both cases, the Domain Name System server shall return a response to the client based on configured values. If there is not a complete match in both cases, the Domain Name System server shall return an appropriate negative response which does not preclude other domain names or sub-domains existing (“no address available”).

The invention will be defined with more precision in the appended claims to which reference should now be made.

### BRIEF DESCRIPTION OF THE DRAWINGS

A preferred embodiment of the invention will now be described in detail by way of example with reference to the accompanying drawings in which:

FIG. 1 is a schematic diagram showing the connections between a client and two Domain Name System servers in an embodiment of the invention;

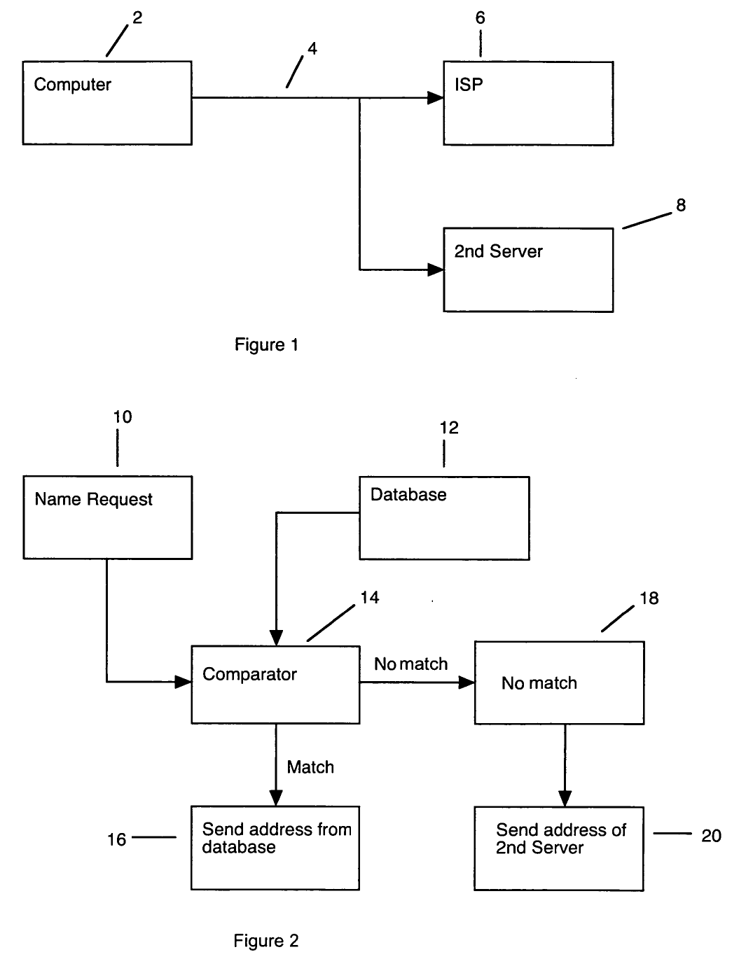

FIG. 2 is a schematic diagram showing how address requests are resolved at a Domain Name System server;

FIG. 3 shows a schematic diagram of the address resolution portion of a second server embodying the invention;

FIG. 4 is a flow chart showing the processes performed by the first server in an embodiment of the invention;

FIG. 5 is a flow chart showing the processes performed by the second server in an embodiment of the invention; and

FIG. 6 is a block diagram showing an example of requests and responses between a client computer and primary and secondary servers.

A client computer (usually a PC) 2 is shown. This is connected via a communications medium such as a telephone line 4 to an Internet Access Provider (IAP) 6, who allow Internet Protocol connections to be established with many different kinds of services including DNS servers. Address requests are exchanged between the client computer and the DNS server 7.

A second server 8 is also illustrated, with which the client computer may communicate with when it is referred to by the first server 7.

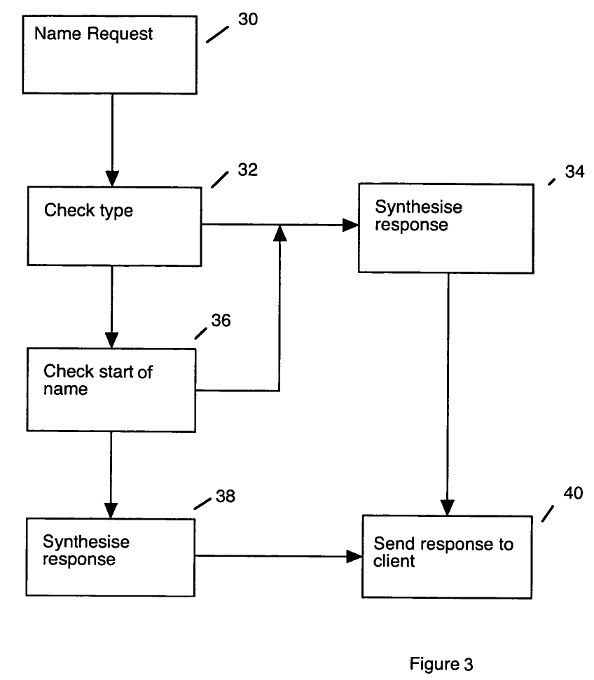

When a client computer wishes to access a particular Internet host, it sends an address resolution request over the communications medium 4 via its IAP 6 to the first DNS server 7. This process is illustrated with reference to FIG. 2. This DNS server contains a database with many names and associated information, including but not limited to Internet Protocol addresses. When a name resolution request is received the name is compared in turn with the names stored in the database 12 in a comparator 14. If a match between the name is found with a name stored in the database 12 then the corresponding data is retrieved at 16 and returned to the client computer 2.

In some circumstances no match will be found between the name requested and the names stored in the database 12. This may arise for any number of reasons; for example if a user has mistyped the name or the name is being tried speculatively. In such a situation no match will be made by the comparator and a response will be generated containing the names or addresses of the secondary server (or servers) referring the client to them for further information.

The second server 8 upon receipt of a name resolution request (typically as the result of a referral sent by the first DNS server 7) it will compare the requested name and request type with configured values; if it is the case that these values match then the second DNS server will respond with a positive answer containing a set of configured address values. If it is not the case that the values match, then the second DNS server will send a response to the client indicating that no information of the specified type is available.

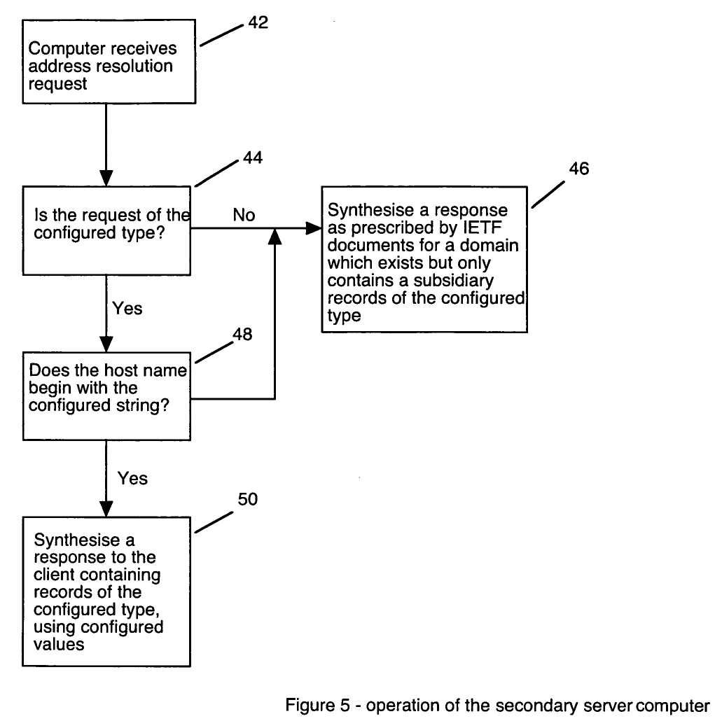

For completeness, a flow diagram showing this process is given in FIG. 4. At 22 the first DNS server receives an address resolution request. It then determines at 24 whether or not the requested name is present within its database. If it is then the result is returned to the client computer at 26. If it is not, then the secondary server address information is sent to the client at 28. This can be considered as a synthesised referral response.

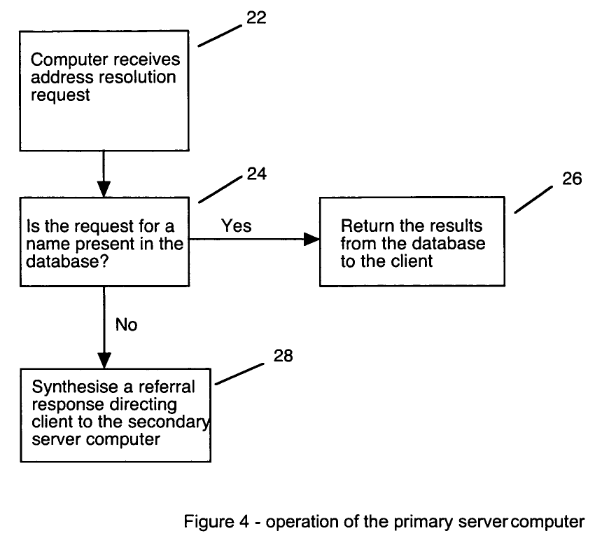

In FIG. 3 the schematic diagram of the secondary server is shown. This comprises a store 30 for the received named request. A first step performed by the second server is to check the type of a received name resolution request at 32. (e.g. type=address). Here the second server is checking whether or not the request is for data of the configured type.

If the name is not of the configured type or is an unrecognised type, then a response synthesiser 34 is activated which creates a response indicating no addresses of the specified type are available in accordance with the DNS protocols currently specified in Internet Engineering Task Force documents RFC1034, RFC1035, RFC1124 and RFC2101, the contents of which are incorporated herein by reference.

If the type of record is determined at 32 to be of the configured type (e.g. “address”) then at 36 the first components of the name are checked. In an address type request, this checks whether the name begins with the configured string (e.g. “www”). If it does, the 38 secondary server synthesises a response to the client computer which contains a set of configured values. In an address type request this will be an IP address to which the client is directed.

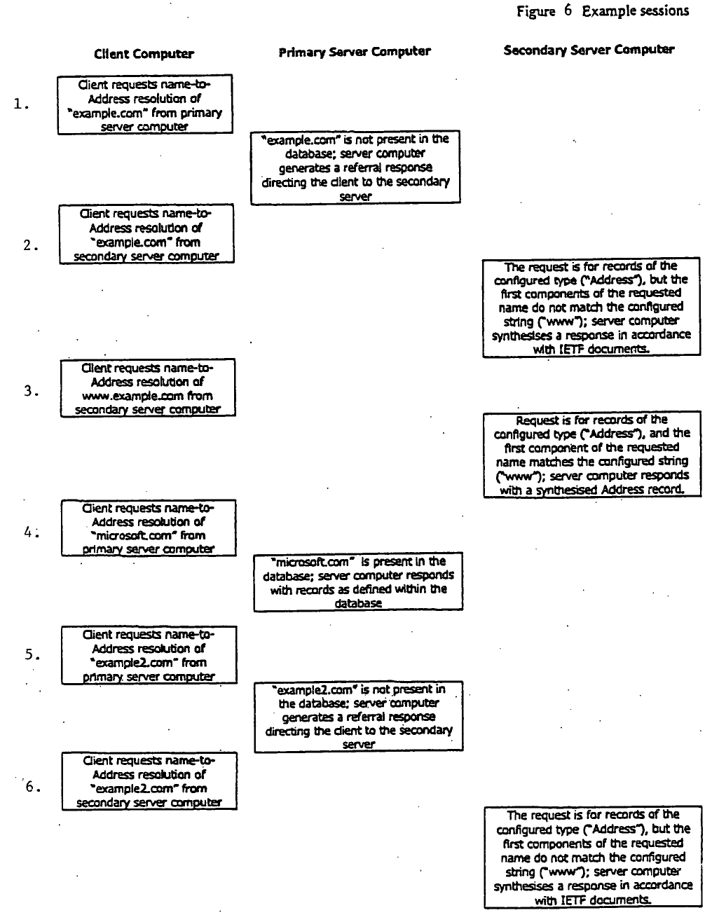

The IP address may be a web site which prompts a user for different spellings of his typed domain, it may offer to sell him the domain, or it may be some other kind of service. The secondary server may have more than one configured response which may return to the client. This may be useful in load balancing or it may be used to send the user to different addresses or types of services in dependence of the type of request received from a client. The steps performed at the secondary server by the system of FIG. 3 are shown in the flow chart of FIG. 5. In this a computer receives an address resolution request at 42 and determines at 44 whether or not the request is of the configured (e.g. address) type. If it is not then a synthesised response is provided as discussed above at 46. If it is of the configured type then a determination is made at 48 as to whether or not the name begins with a configured string (e.g. “www” for an address request). If it does not then again a synthesised response is sent as at 46. Otherwise, a synthesized response is produced at So which contains a set of configured values, namely an IP address to which the client is directed.

In operation it is the purpose of the secondary server to return to a client a valid and correct response to client resolution requests for any given name. The primary server at the ISP compares a name request with the name stored on its database and if a valid match can be found returns the relevant Internet address details to the user. If no valid match can be found then a referral address for the secondary server is sent to the client and connection made to the secondary server. This secondary server then attempts to return a valid and correct response to the resolution request. If the request is not of the configured type then known communication protocols for client resolution requests are used and a response is synthesized to the user based on these. If a host name begins with a known string and the request is of a known type then the response to the user is sent with a configured address to which the user is directed.

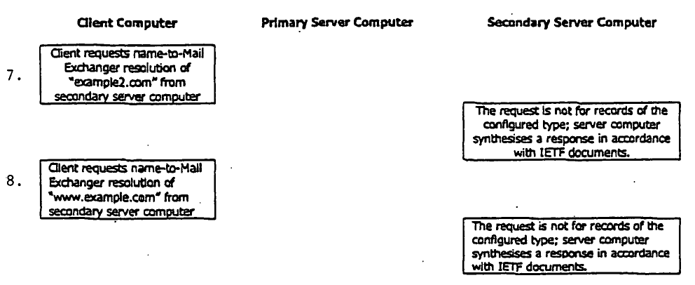

FIG. 6 shows a series of client computer requests and responses from the primary server and the secondary server. These are explained below with reference to the numerals on the figure?
1. A client requests a name and address resolution of “example.com” from the primary server. In this case the primary server checks example.com against its database and finds that it is not present. The primary server then generates a referral response directing the client to the secondary server.
2. The client requests name and address resolution of example.com from the secondary server computer. A secondary server determines that the first components of the name do not match the configured string www. Therefore the secondary server synthesizes a response in accordance with protocols disclosed in the IETF documents.
3. Client requests a name to address resolution of “www.example.com” from the secondary server computer. In this case the request is for a record of the configured type (address) and the first component of the requested name matches the configured string (www). The server computer therefore responds with a synthesized address record to which the client is directed.
4. Client requests name to address resolution of “Microsoft.com” from the primary server. This name is present in the database of the primary server and the relevant records from the database are sent back to the client.
5. The client requests name to address resolution of “example2.com” from the primary server. Example2.com is not present in the database and a referral response to the secondary server is sent to the client.
6. The client requests name and address resolution of “example2.com” in a secondary server computer. The first components with the requested name do not match the configured string www and so a response is synthesized in accordance with the IETF documents.
7. Client requests name to mail exchanger resolution of “example2.com” from the secondary server. Again this request is not for records of configured type and the server computer synthesizes a response in accordance with the IETF documents.
8. The client requests name to mail exchanger resolution of “www.example2.com” from secondary server. This is determined not to be for records of the configured type and the server synthesizes a response in accordance with the IETF documents.

It can be seen that using embodiments of the invention, an individual DNS server which does not recognise a name from a name request, and is therefore unable to return data stored in relation to the name from its database, can perform referrals to one or more other domain name servers. This referral is synthesized automatically to the other domain name server which will field the requests. Checks can be performed upon the requested name and synthesized responses based on configured parameters provided to the user. This enables a much more useful response to be provided to the user, such as a referral to known services. Embodiments of the invention can be developed which prompt the user for possible spelling errors or look for valid domain names within a typed string. Thus significant improvements over systems which simply return a domain name unknown response are obtained.

1. A method for resolving an address request in a computer system comprising the steps of:
receiving a name at a first server with a request for an address corresponding to that name;
comparing the name with a database of names to detect any matching name in the database; and
if no matching name is detected, sending a referral response in answer to the request.

2. A method according to claim 1 in which the first server is a domain name server and the referral is to a second domain name server.

3. Apparatus for resolving an address request in a computer system comprising:
means for receiving a name at a first server with a request for an address corresponding to that name;
means for comparing the name with a database of names to detect any matching name in the database; and
means for sending a referral in answer to the request if no matching name is detected.

4. Apparatus according to claim 3 in which the first server is a domain name server and the referral is to a second domain name server.

5. A method for resolving an unknown address request in a computer system comprising the steps of:
receiving a referred request from a user;
performing a sequence of tests on the request; and
sending a synthesized address response to the user.

6. A method according to claim 5 in which the sequences of tests including the step of determining the type of the request.

7. A method according to claim 5 in which the sequence of tests including determining whether the start of a request matches a known string of characters.

8. A method according to claim 5 in which the request is a name to address resolution request.

9. A method according to claim 5 in which the synthesized response comprises an Internet Protocol address.

10. Apparatus for resolving an unknown address request in a computer system comprising means for receiving a referral request from a user;
means for performing a sequence of tests in the request; and
means for sending a synthesized address response to the user.

11. (cancelled)

12. (cancelled).
